(19) United States
(12) Patent Application Publication
(10) Pub. No.: US 2013/0153813 A1
(43) Pub. Date: Jun. 20, 2013

(54) POLING TREATMENT METHOD, PLASMA POLING DEVICE, PIEZOELECTRIC SUBSTANCE, AND MANFACTURING METHOD THEREFOR

(71) Applicants: Yuuji Honda, Chiba (JP); Takeshi Kijima, Chiba (JP); Koji Abe, Chiba (JP)

(72) Inventors: Yuuji Honda, Chiba (JP); Takeshi Kijima, Chiba (JP); Koji Abe, Chiba (JP)

(73) Assignee: Youtec Co. Ltd., Chiba (JP)

(21) Appl. No.: 13/812,075

(22) PCT Filed: Jul. 27, 2010
(86) PCT No.: PCT/JP2010/062599

§ 371 Date: Feb. 28, 2013

(51) Int. Cl. B23K 31/00

(52) U.S. Cl. CPC B23K 31/00
USPC 252/62.9 R; 219/121.47

(57) ABSTRACT

The plasma poling device includes: a holding electrode 4 being disposed in a poling chamber 1 and holding a substrate to be subjected to poling 2 thereon; an opposite electrode 7 being disposed in the poling chamber and being disposed opposite to the substrate to be subjected to poling held on the holding electrode; a power source 6 being electrically connected to either the holding electrode or the opposite electrode; a gas supply mechanism supplying a gas for forming plasma to a space between the opposite electrode and the holding electrode; and a control unit controlling the power source and the gas supply mechanism, wherein the control unit controls the power source and the gas supply mechanism, so as to form a plasma at a position opposite to the substrate to be subjected to poling to thereby perform poling treatment on the substrate to be subjected to poling.

### TECHNICAL FIELD

The present invention relates to a poling treatment method performing poling treatment by plasma, a plasma poling device, a piezoelectric substance, and a manufacturing method therefor.

### BACKGROUND ART

FIG. 3 is a schematic drawing illustrating a conventional poling device.

A crystal 33 is sandwiched between a pair of electrodes 35 formed by two parallel plates each having an area of 10×10 mm², at the center therebetween so as an electric field to be applied in the direction not being subjected to mechanical poling. Then, the crystal 33 together with the electrodes 35 is immersed in an oil 36 in an oil bath 37, and the oil 36 having immersed the crystal 33 is heated to 125° C. by a heater 38. After the temperature reaches a specified level, a direct-current electric field of 1 kV/cm is applied, for 10 hours, between the electrodes 35 via a lead 40 from a high voltage power source 39. As a result, the crystal 33 is subjected to poling treatment. (For example, refer to Patent Document 1.)

### PRIOR ART DOCUMENTS

### Patent Document

Patent Document 1
Japanese Patent Laid-Open No. 10-177194 (Paragraph 0018 and FIG. 4)

### DISCLOSURE OF THE INVENTION

### Problems to be Solved

The above-described conventional poling treatment method is the wet process in which a material to be subjected to poling is immersed in oil in a state of being sandwiched between a pair of electrodes at the center therebetween, and thus the conventional method has a problem of troublesome poling treatment.

An aspect of the present invention is to provide any of poling treatment method, plasma poling device, piezoelectric substance, and manufacturing method therefor by a dry process, allowing easily performing poling treatment.

### Solutions to the Problems

An aspect of the present invention is a method of poling treatment which is characterized by including the step of forming a plasma at a position opposite to a substrate to be subjected to polling, to thereby perform poling treatment on the substrate to be subjected to poling.

Furthermore, in an aspect of the present invention, the substrate to be subjected to poling can be a substrate having a dielectric substance.

In an aspect of the present invention, the substrate to be subjected to poling can be a substrate having a ferroelectric substance.

In an aspect of the present invention, the temperature of the substrate to be subjected to poling in performing the poling treatment can be 250° C. or less.

In an aspect of the present invention, a direct-current voltage at the time of forming a direct-current plasma at a position opposite to the substrate to be subjected to poling or a direct-current voltage component at the time of forming a high frequency plasma at a position opposite to the substrate to be subjected to poling can be in a range of ±50 V to ±2 kV.

In an aspect of the present invention, the pressure in forming the plasma can be in a range of 0.01 Pa to atmospheric pressure.

Moreover, in an aspect of the present invention, the gas for forming plasma in forming the plasma is preferably one or more of the gases selected from the group consisting of an inert gas, H₂, N₂, O₂, F₂, CₓH_{y}, CₓF_{y}, and air.

An aspect of the present invention is a piezoelectric substance which is characterized by performing poling treatment on a substrate having the ferroelectric substance by using any of the above-described poling treatment methods, to thereby provide the ferroelectric substance with piezoelectric activity.

An aspect of the present invention is a plasma poling device which includes:

a poling chamber;

a holding electrode being disposed in the poling chamber and holding a substrate to be subjected to poling thereon;

an opposite electrode being disposed in the poling chamber and being disposed opposite to the substrate to be subjected to poling held on the holding electrode;

a power source being electrically connected to either the holding electrode or the opposite electrode;

a gas supply mechanism supplying a gas for forming plasma to a space between the opposite electrode and the holding electrode; and

a control unit controlling the power source and the gas supply mechanism, wherein

the control unit controls the power source and the gas supply mechanism, so as to form a plasma at a position opposite to the substrate to be subjected to poling to thereby perform poling treatment on the substrate to be subjected to poling.

An aspect of the present invention is a plasma poling device which includes:

a poling chamber;

a holding electrode being disposed in the poling chamber and holding a substrate to be subjected to poling thereon;

an opposite electrode being disposed in the poling chamber and being disposed opposite to the substrate to be subjected to poling held on the holding electrode;

first power source and a ground potential being connected to the holding electrode via a first selector switch;

a second power source and the ground potential being connected to the opposite electrode via a second selector switch;

a gas supply mechanism supplying a gas for forming plasma to a space between the opposite electrode and the holding electrode; and

a control unit controlling the first power source, the second power source, and the gas supply mechanism, wherein

the first selector switch is a switch for switching from a first state in which the holding electrode and the first power source are electrically connected, to a second state in which the holding electrode and the ground potential are electrically connected,

the second selector switch is a switch for switching from a third state in which the opposite electrode and the ground potential are electrically connected, to a fourth state in which the opposite electrode and the second power source are electrically connected, and

the control unit controls the first power source, the second electrode, and the gas supply mechanism, so as to form a plasma at a position opposite to the substrate to be subjected to poling in the first state and the third state or in the second state and the fourth state to thereby perform poling treatment on the substrate to be subjected to poling.

In addition, an aspect of the present invention further includes a heating mechanism which heats the substrate to be subjected to poling, wherein the substrate to be subjected to poling can be a substrate having a dielectric substance.

In an aspect of the present invention, the substrate to be subjected to poling can be a substrate having a ferroelectric substance.

An aspect of the present invention further can include a temperature controlling mechanism controlling the temperature of the substrate to be subjected to poling in performing the poling treatment, to 250° C. or less.

In an aspect of the present invention, a direct-current voltage in forming a direct-current plasma by supplying a power to either the holding electrode or the opposite electrode, or a direct-current voltage component in forming a high frequency plasma can be in a range of ±50 V to ±2 kV.

An aspect of the present invention further can include a pressure controlling mechanism controlling internal pressure of the poling chamber in performing the poling treatment in a range of 0.01 Pa to atmospheric pressure.

Furthermore, in an aspect of the present invention, the gas for forming plasma is preferably one or more of the gases selected from the group consisting of an inert gas, H₂, N₂, O₂, F₂, CₓH_{y}, CₓF_{y}, and air. However, when poling is performed using H₂, the surface of the material to be subjected to poling is preferably covered with a film resistant to hydrogen reduction.

An aspect of the present invention is a piezoelectric substance which is characterized by performing poling treatment on a substrate having the ferroelectric substance by using any of the above-described plasma poling devices, to thereby provide the ferroelectric substance with piezoelectric activity.

An aspect of the present invention is a method of manufacturing a piezoelectric substance which includes the steps of:

preparing a substrate having a ferroelectric substance; and

forming a plasma at a position opposite to the substrate to thereby perform poling treatment on the ferroelectric substance, thus providing the ferroelectric substance with piezoelectric activity to form a piezoelectric substance.

Moreover, an aspect of the present invention is the method of manufacturing a piezoelectric substance, wherein the poling treatment is performed by a plasma poling device, and the plasma poling device can include:

a poling chamber;

a holding electrode being disposed in the poling chamber and holding the substrate thereon;

an opposite electrode being disposed in the poling chamber and being disposed opposite to the substrate held on the holding electrode;

a power source being electrically connected to either the holding electrode or the opposite electrode; and

a gas supply mechanism supplying a gas for forming plasma to a space between the opposite electrode and the holding electrode.

An aspect of the present invention is the method of manufacturing a piezoelectric substance, wherein the poling treatment is performed by a plasma poling device, and the plasma poling device can include:

a poling chamber;

a holding electrode being disposed in the poling chamber and holding the substrate thereon;

an opposite electrode being disposed in the poling chamber and being disposed opposite to the substrate held on the holding electrode;

a first power source and a ground potential being connected to the holding electrode via a first selector switch;

a second power source and the ground potential being connected to the opposite electrode via a second selector switch; and

a gas supply mechanism supplying a gas for forming plasma to a space between the opposite electrode and the holding electrode.

### Effect of the Invention

According to an aspect of the present invention, there can be provided any of the poling treatment method, the plasma poling device, the piezoelectric substance, and the manufacturing method therefore, allowing easily performing the poling treatment by a dry process.

### BRIEF DESCRIPTION OF THE DRAWINGS

FIG. 1 is a schematic cross-sectional view of a plasma poling device according to an aspect of the present invention.

FIG. 2 is a schematic cross-sectional view of a plasma poling device according to an aspect of the present invention.

FIG. 3 is a schematic drawing illustrating a conventional poling device.

### BEST MODE FOR CARRYING OUT THE INVENTION

Hereinafter, the embodiments of the present invention will be described in detail referring to the drawings. However, the present invention is not limited to the following description, and a person skilled in the art can readily understand that various modifications of the form and detail of the description are possible without departing from the gist and scope of the present invention. Consequently, the present invention should not be interpreted as being limited to the contents of the description of the embodiments given below.

### First Embodiment

### <Plasma Poling Device>

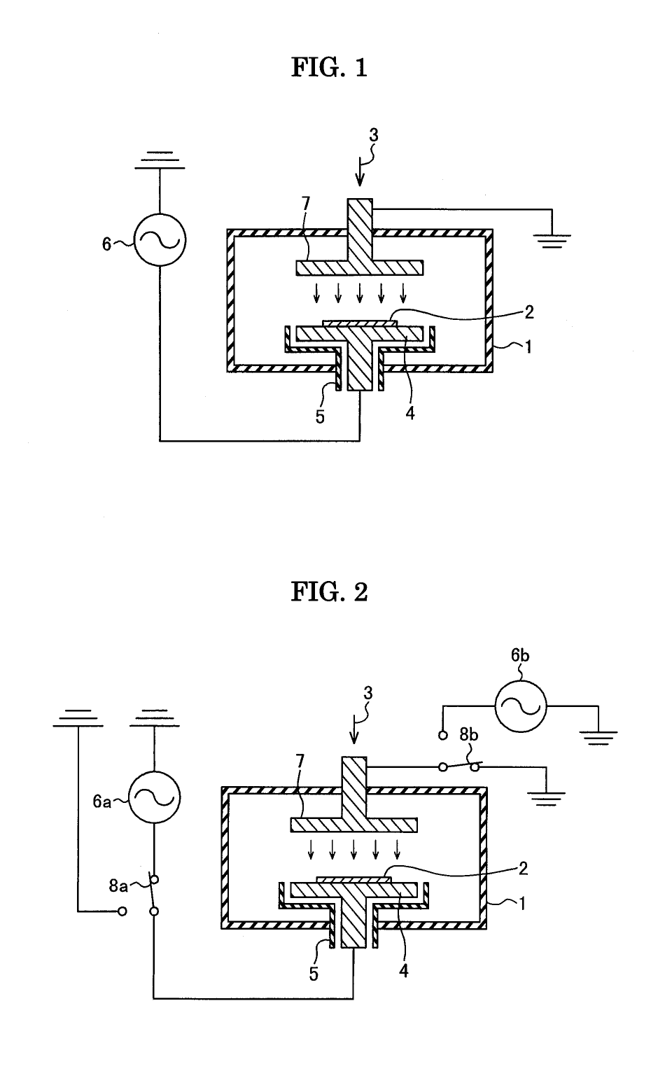

FIG. 1 is a schematic cross-sectional view illustrating a plasma poling device according to an aspect of the present invention. The plasma poling device is a device for performing poling treatment.

The plasma poling device has a poling chamber 1. Below the poling chamber 1, there is disposed a holding electrode 4 which holds a substrate to be subjected to poling 2 thereon. The detail of the substrate to be subjected to poling 2 is described later. For example, the substrate to be subjected to poling 2 is a substrate having a ferroelectric substance, and the substrate having various shapes of substrate can be used.

The holding electrode 4 is electrically connected to a high frequency power source 6, and also functions as an RF-applying electrode. The periphery and the lower part of the holding electrode 4 are shielded by an earth shield 5. Note that although, in the embodiment, the high frequency power source 6 is used, there maybe used other power sources such as direct-current power source and microwave power source.

On the upper side of the poling chamber 1, there is positioned a gas-shower electrode (opposite electrode) 7 at a parallel position opposite to the holding electrode 4. These holding electrode 4 and gas-shower electrode 7 form a pair of parallel plate-type electrodes. The gas-shower electrode is connected to the ground potential. Note that, in the embodiment, the power source is connected to the holding electrode 4, and the ground potential is connected to the gas-shower electrode. However, the ground potential may be connected to the holding electrode 4, and the power source may be connected to the gas-shower electrode.

On the lower surface of the gas-shower electrode 7, there is formed a plurality of gas supply openings (not shown) which supplies the gas for forming plasma in a shower shape, on the surface side of the substrate to be subjected to poling (the space between the gas-shower electrode 7 and the holding electrode 4). As gases for forming plasma, for example, Ar, He, N₂, O₂, F₂, CₓF_{y}, and air can be used.

Inside the gas-shower electrode 7, a gas-introduction passage (not shown) is provided. An end of the gas-introduction passage is connected to the gas supply openings, while the other end thereof is connected to the gas supply mechanism 3 of the gas for forming plasma. In addition, the poling chamber 1 has an exhaust opening which evacuates an internal space of the poling chamber 1. The exhaust opening is connected to an evacuation pump (not shown).

Furthermore, the plasma poling device has a control unit (not shown) which controls the high frequency power source 6, the gas supply mechanism 3 for the gas for forming plasma, the evacuation pump, and the like. The control unit controls the plasma poling device so as to perform the poling treatment described later.

In addition, the plasma poling device preferably has a temperature control mechanism which controls the temperature of the substrate to be subjected to poling 2 to 250° C. or less, in performing the poling treatment.

### <Poling Treatment Method>

Next, the description will be given on the method of performing poling treatment on a substrate to be subjected to poling by using the above-described poling device. The term “poling treatment method” according to the present invention not only signifies what is called the poling treatment in intense electric field (that is, polarization treatment is a process of applying a direct-current high electric field to a ceramic-chip provided with an electrode, to thereby provide the ferroelectric substance with piezoelectric activity), but also signifies thermal poling. This thermal poling makes it possible to, especially above all, apply direct-current voltage or high-frequency power to a dielectric substance while heating thereof, and to cut off the voltage or the high frequency power, thereby providing the dielectric substance with anisotropy in advance. Giving thermal energy causes ions inside the dielectric substance to reach an easily moving state, and when a voltage is applied to the dielectric substance in this state, the transport and polarization of ions are induced, which causes the entire substrate to perform quick poling.

Note that, in performing the thermal poling treatment, it is necessary to add a heating mechanism to the above-described plasma poling device and to heat the substrate to be subjected to poling by this heating mechanism.

### [1] Substrate to be Subjected to Poling

First, the substrate to be subjected to poling 2 is prepared. The substrate to be subjected to poling 2 is a substrate subjected to the poling treatment, for example, a substrate having a ferroelectric substance. In this poling treatment, there can also be used various kings of substrate to be subjected to poling, because the poling treatment is effective for all kinds of inorganic and organic materials having superconductive, dielectric, piezoelectric, pyroelectric, ferroelectric, and nonlinear optical properties.

Specific examples of materials which can be substrates to be subjected to poling 2 are: TiO₂, MgTiO₃—CaTiO₃ based compound, BaTiO₃ based compound, CaSnO₃, SrTiO₃, PbTiO₃, CaTiO₃, MgTiO₃, SrTiO₃, CaTiO₃ based compound: BaTiO₃ based compound, BaO—R₂O₃-nTiO₂ based compound (R=Nd, Sm . . . , n=4, 5 . . . ), Al₂O₃, diamond based compound (diamond-like can, and the like), BN, SiC, BeO, AlN, BaTi₅O₁₁, Ba₂Ti₉O₂₀, tungsten bronze AₓBO₃: Ba₂NaNb₅O₁₅ (BNN), Ba₂NaTa₅O₁₅ (ENT), Sr₂NaNb₅O₁₅ (SNN), K₃Li₂Nb₅O₁₅ (KLN), K₂BiNb₅O₁₅ (KEN), perovskite based compound, (K, Na, Li) (Nb, Ta, Sb) O₃, BiₓNa₁₋ₓTiO₃ (BNT), BiₓK₁₋ₓTiO₃ (BKT), BiFeO₃, SrBi₂Ta₂O₉ (SET), Bi₄Ti₃O₁₂, Bi₄₋ₓLaₓTi₃O₁₂ (BLT), SrBi₂Nb₂O₉ (SBN), Bi₂WO₄ (BWO) SiO₂, LiNbO₃, LiTaO₃, Sr_{0.5}Ba_{0.5}Nb₂O₆, KDP (KH₂PO₄), C₄H₄O₆NaK-4H₂O, NaNO₂, (NH₂)₂CS, K₂SeO₄, PbZrO₃, (NH₂)₂CS, (NH₄)SO₄, NaNbO₃, BaTiO₃, PbTiO₃, SrTiO₃, KNbO₃, NaNbO₃, BiFeO₃, (Na, La) (Mg, W)O₃, La_{1/3}NbO₃, La_{1/3}TaO₃, Ba₃MgTa₂O₉, Sr₄NaSb₃O₁₂, A₂BRO₆ (A is alkali earth group, B is Fe or Ln, R is Mo, Mn, W, or Ru, difference of valence between B and R is 2 or more), Bi₂NiMnO₆, Sr₂FeMoO₆, BaLnMn₂O₆, NaₓWO₃, Ln_{1/3}NbO₃, Ba₂In₂O₅, Sr₂Fe₂O₅, Sr₂Nd₂O₇, Sr₂Ta₂O₇, La₂Ti₂O₇, MgSiO₃, CaIrO₃, CuNMn₃, GaNMn₃, ZnNMn₃, CuNMn₃, Ca₂MnO₄, FeTiO₃, LiNbO₃, LiTaO₃, Gd₂ (MoO₄)₃, SrTiO₃, KTaO₃, RFe₂O₄, La₂₋ₓSrₓCuO₄, Me₃B₇O₁₃X (Me is ion radius 0.97 ∈ (Cd²⁺) to 0.66 Å (Mg²⁺), X is halogen), Ni₃B₇O₁₃I, BiFeO₃, BiMnO₃, Pb₂(Co_{1/2}W_{1/2})O₃, Pb(Fe_{1/2}Nb_{1/2})O₃, A₂BRO₆ (A is alkali earth group, B is Fe or Ln, R is Mo, Mn, W, or Ru, difference of valence between B and R is 2 or more), Bi₂NiMnO₆, YMnO₃, YbMnO₃, HoMnO₃, BaMnF₄, BaFeF₄, BaNiF₄, BaCoF₄, YFe₂O₄, LuFe₂O₄, TbMnO₃, DyMnO₃, Ba₂Mg₂Fe₁₂O₂₂, CuFeO₂, Ni₃V₂O₈, LiCu₂O₂, LiV₂O₄, LiCr₂O₄, NaV₂O₄, NaCr₂O₄, CoCr₂O₄, LiFeSi₂O₆, NaCrSi₂O₆, LiFeSi₂O₆, NaCrSi₂O₆, MnWO₄, TbMn₂O₅, DyMn₂O₅, HoMn₂O₅, YMn₂O₅, R=Tb,Dy,Ho, or Y, RbFe(MoO₄)₂, Pr₃Ga₅SiO₁₄, Nd₃Ga₅SiO₁₄, Nd₃Ga₅SiO₁₄, A₃BFe₃Si₂O₁₄, A=Ba,Sr, or Ca, B═Nb, T is various pyrochlore oxides, quartz (SiO₂), LiNbO₃, BaTiO₃, PbTiO₃ (PT), Pb(Zr,Ti)O₃ (PZT), Pb(Zr,Ti,Nb)O₃ (PZTN), PbNb₂O₆, PVF₂, PMN-PZT, lead magnesium niobate-PZT based compound >Pb(Mg_{1/3}Nb_{2/3})O₃ (PMN)-PZT, Pb(Ni_{1/3}Nb_{2/3})O₃ (PNN)-PZT, Pb(_{Mg}_{1/3}Nb_{2/3})O₃ (PMN)-PT, Pb(Ni_{1/3}Nb_{2/3})O₃ (PNN)-PT, Pb(Mg_{1/3}Nb_{2/3})O₃—PbTiO₃ (PMN-PT), BaTiO₃, (Sr₁₋ₓ,Baₓ)TiO₃, (Pb_{1-y},Ba_{y}) (Zr₁₋ₓTiₓ)O₃: (where x=0-1, Y=0-1), CdTiO₃, HgTiO₃, CaTiO₃, GdFeO₃, SrTiO₃, PbTiO₃, BaTiO₃, PbTiO₃, PbZrO₃, Bi_{0.5}Na_{0.5}TiO₃, Bi_{0.5}K_{0.5}TiO₃, KNbO₃, LaAlO₃, FeTiO₃, MgTiO₃, CoTiO₃, NiTiO₃, CdTiO₃, (K₁₋ₓNaₓ)NbO₃, K(Nb₁₋ₓTaₓ)O₃, (K₁₋ₓNaₓ) (Nb_{1-y}Ta_{y})O₃, KNbO₃, RbNbO₃, TlNbO₃, CsNbO₃, AgNbO₃, Pb(Ni_{1/3}Nb_{2/3})O₃, Ba(Ni_{1/3}Nb_{2/3})O₃, Pb(Sc_{1/2}Nb_{1/2})O₃, (Na_{1/2}Bi_{1/2})TiO₃, (K_{1/2}Bi_{1/2})TiO₃, (Li_{1/2}Bi_{1/2}) TiO₃, Bi(Mg_{1/2}Ti_{1/2})O₃, Bi(Zn_{1/2}Ti_{1/2})O₃, Bi(Ni_{1/2}Ti_{1/2})O₃, (Bi, La) (Mg_{1/2}Ti_{1/2})O₃, (A¹⁺_{1/2}A³⁺_{1/2}) (B²⁺_{1/3}B⁵⁺_{2/3})O₃: (A and B are substituted with elements such as A¹⁺=Li, Na, K, or Ag; A²⁺=Pb, Ba, Sr, or Ca; A³⁺=Bi, La, Ce, or Nd; B¹⁺═Li or Cu; B²⁺═Mg, Ni, Zn Co, Sn, Fe, Cd, Cu, or Cr; B³⁺═Mn, Sb, Al, Yb, In, Fe, Co, Sc, Y, or Sn; B⁴⁺═Ti or Zr; B⁵⁺═Nb, Sb, Ta, or Bi; B⁶⁺═W, Te, or Re), Pb(Mg_{1/3}Nb_{2/3})O₃ (PMN), Pb(Mg_{1/3}Ta_{2/3})O₃ (PMTa), Pb(Mg_{1/2}W_{1/2})O₃ (PMW), Pb(Ni_{1/3}Nb_{2/3})O₃ (MIN), Pb(Ni_{1/3}Ta_{2/3})O₃ (PNTa), Pb(Ni_{1/2}W_{1/2})O₃ (PNW), Pb(Zn_{1/3}Nb_{2/3})O₃ (PZN), Pb(Zn_{1/3}Ta_{2/3})O₃ (PZTa), Pb(Zn_{1/2}W_{1/2})O₃ (PZW), Pb(Sc_{1/2}Nb_{1/2})O₃ (PScN), Pb(Sc_{1/2}Ta_{1/2})O₃ (PScTa), Pb(Cd_{1/3}Nb_{2/3})O₃ (PCdN), Pb(Cd_{1/3}Ta_{2/3})O₃ (PCdT), Pb (Cd_{1/2}W_{1/2})O₃ (PCdW), Pb(Mn_{1/3}Nb_{2/3})O₃ (PMnN), Pb(Mn_{1/3}Ta_{2/3})O₃ (PMnTa), Pb(Mn_{1/2}W_{1/2})O₃ (PMnW), Pb(Co_{1/3}Nb_{2/3})O₃ (PCoN), Pb(Co_{1/3}Ta_{2/3}))₃ (PCoTa), Pb(Co_{1/2}W_{1/2})O₃ (PCoW), Pb(Fe_{1/2}Nb_{1/2})O₃ (PFN), Pb(Fe_{1/2}Ta_{1/2})O₃ (PFTa), Pb(Fe_{2/3}W_{1/3})O₃ (PFW), Pb(Cu_{1/3}Nb_{2/3})O₃ (PCuN), Pb(Yb_{1/2}Nb_{1/2})O₃ (PYbN), Pb(Yb_{1/2}Ta_{1/2})O₃ (PYbTa), Pb(Yb_{1/2}W_{1/2})O₃ (PYbW), Pb(Ho_{1/2}Nb_{1/2})O₃ (PHoN), Pb(Ho_{1/2}Ta_{1/2})O₃ (PHoTa), Pb(Ho_{1/2}W_{1/2})O₃ (PHoW), Pb(In_{1/2}Nb_{1/2})O₃ (PInN), Pb(In_{1/2}Ta_{1/2})O₃ (PInTa), Pb(In_{1/2}W_{1/2})O₃ (PInW), Pb(Lu_{1/2}Nb_{1/2})O₃ (PLuN), Pb(Lu_{1/2}Ta_{1/2})O₃ (PLuTa), Pb(Lu_{1/2}W_{1/2})O₃ (PLuW), Pb(Er_{1/2}Nb_{1/2})O₃ (PErN), Pb(Er_{1/2}Ta_{1/2})O₃ (PErT), Pb(Sb_{1/2}Nb_{1/2})O₃ (PSbN), Pb(Sb_{1/2}Ta_{1/2})O₃ (PSbT), BaZrO₃—BaTiO₃, BaTiO₃—SrTiO₃, Pb(Mg_{1/3}Nb_{2/3})O₃, Pb(Sc_{1/2}Nb_{1/2})O₃, Pb(Mg_{1/3}Nb_{2/3})O₃ (PMN), PMN-PbTiO₃, PMN-PZT, nonlinear optical material (inorganic substance) such as garnet crystal (YAG, YAO, YSO, G SG G, GGG), fluoride crystal (YLF, LiSAF, LiCAF), tungstate crystal (KGW, KYW), banadate crystal (YVO₄, GdVO₄, and the like), and further BBO, CBO, CLBO, YCOB, GdCOB, GdYCOB, KTP, KTA, KDP, and LiNbO₃.

Furthermore, applicable organic nonlinear optical materials include: (R)-(+)-2-(α-methylbenzylamino)-5-nitropyridine (molecular formula/molecular weight: C₁₃H₁₃N₃O₂=243.26), (S)-(−)-2-(α-methylbenzylamino)-5-nitropyridine (molecular formula/molecular weight: C₁₃H₁₃N₃O₂=243.26), (S)-(−)-N-(5-nitro-2-pyridyl)alaninol (molecular formula/molecular weight: C₈H₁₁N₃O₃=197.19), (S)-(−)-N-(5-nitro-2-pyridyl)prolinol (molecular formula/molecular weight: C₁₀H₁₃N₃O₃=223.23), (S)—N-(5-nitro-2-pyridyl)phenylalaninol (molecular formula/molecular weight: C₁₄H₁₅N₃O₃=273.29), 1,3-dimethylurea (molecular formula/molecular weight: C₃H₈N₂O=88.11), 2-(N,N-dimethylamino)-5-nitroacetanilide (molecular formula/molecular weight: C₁₀H₁₃N₃O₃=223.23), 2-amino-3-nitropyridine (molecular formula/molecular weight: C₅H₅N₃O₂139.11), 2-amino-5-nitropyridine (molecular formula/molecular weight: C₅H₅N₃O₂=139.11), 2-aminofluorene (molecular formula/molecular weight: C₁₃H₁₁N=181.23), 2-chloro-3,5-dinitropyridine (molecular formula/molecular weight: C₅H₂ClN₃O₄=203.54), 2-chloro-4-nitro-N-methylaniline (molecular formula/molecular weight: C₇H₇ClN₂O₂=186.60), 2-chloro-4-nitroaniline (molecular formula/molecular weight: C₆H₅ClN₂O₂=172.57), 2-methyl-4-nitroaniline (molecular formula/molecular weight: C₇H₈N₂O₂=152.15), 2-nitroaniline (molecular formula/molecular weight: C₆H₆N₂O₂138.12), 3-methyl-4-nitroaniline (molecular formula/molecular weight: C₇H₈N₂O₂=152.15), 3-nitroaniline (molecular formula/molecular weight: C₆H₆N₂O₂=138.12), 4-amino-4′-nitrobiphenyl (molecular formula/molecular weight: C₁₂H₁₀N₂O₂=214.22), 4-dimethylamino-4′-nitrobiphenyl (molecular formula/molecular weight: C₁₄H₁₄N₂O₂=242.27), 4-dimethylamino-4′-nitrostilben (molecular formula/molecular weight: C₁₆H₁₆N₂O₂=268.31), 4-hydroxy-4′-nitrobiphenyl (molecular formula/molecular weight: C₁₂H₉NO₃215.20), 4-methoxy-4′-nitrobiphenyl (molecular formula/molecular weight: C₁₃H₁₁NO₃=229.23), 4-methoxy-4′-nitrostilben (molecular formula/molecular weight: C₁₅H₁₃NO₃=255.27), 4-nitro-3-picoline-N-oxide (molecular formula/molecular weight: C₆H₆N₂O₃=154.12), 4-nitroaniline (molecular formula/molecular weight: C₆H₆N₂O₂=138.12), 5-nitroindol (molecular formula/molecular weight: C₈H₆N₂O₂=162.15), 5-nitrouracil (molecular formula/molecular weight: C₄H₃N₃O₄=157.08), N-(2,4-dinitrophenyl)-L-alaninemethyl (molecular formula/molecular weight: C₁₀H₁₁N₃O₆=269.21), N-cyanomethyl-N-methyl-4-nitroaniline (molecular formula/molecular weight: C₉H₉N₃O₂=191.19), N-methyl-4-nitro-o-toluidine (molecular formula/molecular weight: C₈H₁₀N₂O₂=166.18), and N-methyl-4-nitroaniline (molecular formula/molecular weight: C₇H₈N₂O₂=152.15). These compounds can be used as the substrate to be subjected to poling 2, but the substrate to be subjected to poling 2 is not limited to the above-listed compounds.

### [2] Poling Treatment

Next, the substrate to be subjected to poling 2 is inserted into the poling chamber 1 and is held on the holding electrode 4 in the poling chamber 1.

After that, the substrate to be subjected to poling 2 is subjected to poling treatment.

In detail, the poling chamber 1 is evacuated by an evacuation pump. Then, the gas for forming plasma such as Ar in a shower shape is introduced into the poling chamber 1 and is supplied to the surface of the substrate to be subjected to poling 2, through the supply openings on the gas-shower electrode 7. The supplied gas for forming plasma is exhausted, by the evacuation pump, outside the poling chamber 1, bypassing through the space between the holding electrode 4 and the earth shield 5. Then, through the balance between the supply rate of the gas for forming plasma and the rate of evacuation, by performing control so as to obtain a desired pressure and a desired flow rate of gas for forming plasma, the inside of the poling chamber 1 is brought into an atmosphere of the gas for forming plasma, high frequency (RF) such as 380 kHz or 13.56 MHz is applied by the high frequency power source 6, and by the generation of plasma, the poling treatment is performed on the substrate to be subjected to poling 2. The poling treatment is preferably performed under the condition of: a pressure of 0.01 Pa to atmospheric pressure; a power source of direct current, high frequency, or microwave; a treatment temperature of 250° C. or less; and a direct-current voltage component in forming plasma of ±50 V to ±2 kV. Next, after performing the poling treatment for a specified period of time, the supply of gas for forming plasma through the supply openings on the gas-shower electrode 7 is stopped and the poling treatment is completed.

For example, when a substrate having ferroelectric substance is used as the substrate to be subjected to poling 2, the above-described poling treatment can provide the ferroelectric substance with piezoelectric activity, thereby being able to manufacture the piezoelectric substance.

According to the present embodiment, the formation of plasma at a position opposite to the substrate to be subjected to poling 2 makes it possible to perform poling treatment on the substrate to be subjected to poling 2. That is, the dry process allows easily performing the poling treatment.

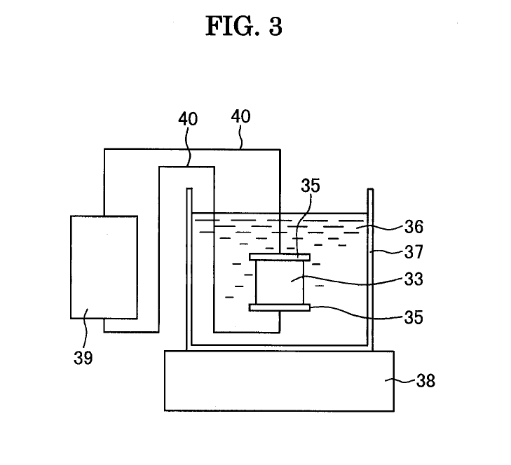

Furthermore, the conventional poling device illustrated in FIG. 3 is a device which performs poling treatment on a bulk material, and is difficult to perform poling treatment on a substrate made of a thin film such as a ferroelectric film. In contrast, the plasma poling device according to the present embodiment easily performs the poling treatment on a substrate made of a thin film such as a ferroelectric film.

Moreover, in performing poling treatment on a ferroelectric film formed on a wafer, the plasma poling device according to the present embodiment can perform poling treatment without dividing the ferroelectric substance into chips.

In addition, although the necessary voltage of the power source differs depending on the thickness of the substrate to be subjected to poling, the plasma poling device according to the present embodiment can perform poling treatment at a power source voltage lower than that of the conventional poling device, and thus the poling device according to the embodiment does not need larger power source unit than that of the conventional poling device.

Furthermore, since the plasma poling device according to the present embodiment performs poling treatment by using plasma, the poling treatment time can be shorter than the time in the case of the conventional poling device, which can improve the productivity of the piezoelectric substance.

Moreover, since the plasma poling device according to the present embodiment does not make use of oil adopted by the conventional poling device, the work environment of the worker caused by vaporization of the oil is never deteriorated.

### Second Embodiment

### <Plasma Poling Device>

FIG. 2 is a schematic cross-sectional view of a plasma poling device according to an aspect of the present invention. The same reference symbol is attached to the same part in FIG. 1, and the following description will be given only to the different parts from FIG. 1.

The holding electrode 4 is electrically connected to a high frequency power source 6a and the ground potential via a selector switch 8a, and the selector switch 8a is configured to apply high frequency power or ground potential to the holding electrode 4. In addition, the gas-shower electrode 7 is electrically connected to a high frequency power source 6b and the ground potential via a selector switch 8b, and the selector switch 8b is configured to apply high frequency power or ground potential to the gas-shower electrode 7. Note that, although in the embodiment, the high frequency power sources 6a and 6b are used, there can be used other power source such as a direct-current power source or a microwave power source.

In addition, the plasma poling device has the selector switches 8a and 8b, the high frequency power sources 6a and 6b, the gas supply mechanism 3 which supplies gas for forming plasma, and the control unit (not shown) controlling the evacuation pump and the like. The control unit controls the plasma poling device so as to perform the poling treatment which is described below.

### <Poling Treatment Method>

Next, the following will be the description of the method of performing poling treatment on a substrate to be subjected to poling by using the above-described plasma poling device.

### [1] Substrate to be Subjected to Poling

First, the substrate to be subjected to poling 2 is prepared. The substrate to be subjected to poling 2 can be the same as that of the first embodiment.

### [2] Poling Treatment

Next, in the same way as that in the first embodiment, the substrate to be subjected to poling 2 is held on the holding electrode 4 in the poling chamber 1.

(1) In the first connecting state, the poling treatment is performed by connecting the high frequency power sources 6a and 6b and the ground potential to the holding electrode 4 and the gas-shower electrode 7.

The first connecting state is a state in which the selector switch 8a connects the high frequency power source 6a to the holding electrode 4, and the selector switch 8b connects the ground potential to the gas-shower electrode 7. Since, in this state, the specific method of performing poling treatment on the substrate to be subjected to poling 2 is the same as that of the first embodiment, further description will be omitted.

(2) In the second connecting state, the poling treatment is performed by connecting the high frequency power sources 6a and 6b and the ground potential to the holding electrode 4 and the gas-shower electrode 7.

The second connecting state is a state in which the selector switch 8a connects the ground potential to the holding electrode 4, and the selector switch 8b connects the high frequency power source 6b to the gas-shower electrode 7. In this state, the specific method of performing poling treatment on the substrate to be subjected to poling 2 will be described below.

The evacuation pump evacuates the poling chamber 1. Then, the gas for forming plasma such as Ar in a shower shape is introduced into the poling chamber 1 and is supplied to the surface of the substrate to be subjected to poling 2, through the supply openings on the gas-shower electrode 7. The supplied gas for forming plasma is exhausted, by the evacuation pump, outside the poling chamber 1, by passing through the space between the holding electrode 4 and the earth shield 5. Then, through the balance between the supply rate of the gas for forming plasma and the rate of evacuation, by performing control so as to obtain a desired pressure and a desired flow rate of gas for forming plasma, the inside of the poling chamber 1 is brought into an atmosphere of the gas for forming plasma, high frequency (RF) such as 380 kHz or 13.56 MHz is applied to the gas-shower electrode 7 by the high frequency power source 6b, and by the generation of plasma, the poling treatment is performed on the substrate to be subjected to poling 2. The poling treatment is preferably performed under the condition of: a pressure of 0.01 Pa to atmospheric pressure; a power source of direct current, high frequency, or microwave; a treatment temperature of 250° C. or less; and a direct-current voltage component in forming plasma of ±50 V to ±2 kV. Next, after performing the poling treatment for a specified period of time, the supply of gas for forming plasma through the supply openings on the gas-shower electrode 7 is stopped and the poling treatment is completed.

For example, when a substrate having ferroelectric substance is used as the substrate to be subjected to poling 2, the above-described poling treatment can provide the ferroelectric substance with piezoelectric activity, thereby being able to manufacture the piezoelectric substance.

Also in the second embodiment, the same effects as those in the first embodiment can be obtained.

### EXAMPLES

Spin-coating was performed using a 25 wt. % sol-gel PZT solution with 15% excessive Pb, (Pb/Zr/Ti=115/52/48). Because of this, the PZT solution was coated on a wafer. The coating amount per coating was set to 500 μL, and by using the conditions described below, the coating of a thick film of PZT was performed.

### (Spin-Coating Condition)

Increase from 0 to 300 rpm in 3 seconds, followed by holding the state for 3 seconds.

Increase from 300 to 500 rpm in 5 seconds, followed by holding the state for 5 seconds.

Increase from 500 to 1500 rpm in 5 seconds, followed by holding the state for 90 seconds.

For every coating, a drying step (water-removing step) was performed by holding the wafer on a hotplate heated to 250° C. for 30 seconds and water was eliminated therefrom. Then, a calcination step was performed by evacuating the atmosphere by using a rotary pump up to an ultimate vacuum of 10⁻¹ Pa, followed by filling N₂ up to the atmospheric pressure, and then heating was performed at 450° C. for 90 seconds to decompose and eliminate the organic substances.

The above coating, drying, and calcination steps were repeated by 3, 6, 9, 12, and 15 times. After that, crystallization treatment was performed in a sintering furnace in an oxygen atmosphere at 700° C. for 5 minutes, and thus PZT thick films each having a total film thickness of 1, 2, 3, 4, and 5 μm were produced.

On the PZT thick films prepared by above sol-gel process, polarization treatment was performed using the plasma poling device shown in FIG. 1.

The power source used was an RF power source of 380 kHZ and 13.56 MHz. Although the treatment conditions vary depending on the film thickness of PZT, the treatment was performed under the condition: a pressure of 1 to 30 Pa, an RF output of 70 to 700 W, an Ar gas flow rate of 15 to 30 seem, a temperature of 25° C., and a treatment time of 1 to 5 minutes. Basically, the treatment was performed under the condition of Vdc=50 V for a film thickness of 1 μm, by referring to the Vdc monitor of the RF power source. That is, in the cases of film thickness of 1, 2, 3, 4, and 5 μm, Vdc was 50, 100, 150, 200, and 250 V, respectively. The treatment time was 1 minute for all of them.

The piezoelectric properties d33 before the polarization treatment, determined by a commercially available d33 meter, were 14, 23, 14, 8, and 13 μm/V. The piezoelectric properties d33 after the polarization treatment were 450, 420, 350, 440, and 400 μm/V, which exhibited remarkable improvement. Therefore, it was confirmed that the piezoelectric properties are remarkably improved by performing the poling treatment on a PZT thick film, through the formation of plasma at a position opposite to the PZT thick film.

### DESCRIPTION OF THE REFERENCE SYMBOLS

1 poling chamber
2 substrate to be subjected to poling
3 gas supply mechanism of gas for forming plasma
4 holding electrode
5 earth shield
6,6a,6b high frequency power source
7,7a,7b gas-shower electrode (opposite electrode)
8a,8b selector switch
33 crystal
35 a pair of electrodes
36 oil
37 oil bath
38 heater
39 high voltage power source
40 lead

1. A method of poling treatment comprising the step of forming a plasma at a position opposite to a substrate to be subjected to polling, to thereby perform poling treatment on said substrate to be subjected to poling.

2. The method of poling treatment according to claim 1, wherein said substrate to be subjected to poling is a substrate having a dielectric substance.

3. The method of poling treatment according to claim 1, wherein said substrate to be subjected to poling is a substrate having a ferroelectric substance.

4. The method of poling treatment according to claim 3, wherein the temperature of said substrate to be subjected to poling in performing said poling treatment is 250° C. or less.

5. The method of poling treatment according to claim 3, wherein a direct-current voltage at the time of forming a direct-current plasma at a position opposite to said substrate to be subjected to poling or a direct-current voltage component at the time of forming a high frequency plasma at a position opposite to said substrate to be subjected to poling is in a range of ±50 V to ±2 kV.

6. The method of poling treatment according to claim 3, wherein the pressure in forming said plasma is in a range of 0.01 Pa to atmospheric pressure.

7. The method of poling treatment according to claim 3, wherein a gas for forming plasma in forming said plasma is one or more of the gases selected from the group consisting of an inert gas, H₂, N₂, O₂, F₂, CₓH_{y}, CₓF_{y}, and air.

8. A piezoelectric substance being obtained by performing poling treatment on a substrate having said ferroelectric substance by using the poling treatment according to claim 3, to thereby provide said ferroelectric substance with piezoelectric activity.

9. A plasma poling device comprising:
a poling chamber;
a holding electrode being disposed in said poling chamber and holding a substrate to be subjected to poling thereon;
an opposite electrode being disposed in said poling chamber and being disposed opposite to said substrate to be subjected to poling held on said holding electrode;
a power source being electrically connected to either said holding electrode or said opposite electrode;
a gas supply mechanism supplying a gas for forming plasma to a space between said opposite electrode and said holding electrode; and
a control unit controlling said power source and said gas supply mechanism, wherein
said control unit controls said power source and said gas supply mechanism, so as to form a plasma at a position opposite to said substrate to be subjected to poling to thereby perform poling treatment on said substrate to be subjected to poling.

10. A plasma poling device comprising:
a poling chamber;
a holding electrode being disposed in said poling chamber and holding a substrate to be subjected to poling thereon;
an opposite electrode being disposed in said poling chamber and being disposed opposite to said substrate to be subjected to poling held on said holding electrode;
a first power source and a ground potential being connected to said holding electrode via a first selector switch;
a second power source and said ground potential being connected to said opposite electrode via a second selector switch;
a gas supply mechanism supplying a gas for forming plasma to a space between said opposite electrode and said holding electrode; and
a control unit controlling said first power source, said second power source, and said gas supply mechanism, wherein
said first selector switch is a switch for switching from a first state in which said holding electrode and said first power source are electrically connected, to a second state in which said holding electrode and said ground potential are electrically connected,
said second selector switch is a switch for switching from a third state in which said opposite electrode and said ground potential are electrically connected, to a fourth state in which said opposite electrode and said second power source are electrically connected, and
said control unit controls said first power source, said second electrode, and said gas supply mechanism, so as to form a plasma at a position opposite to said substrate to be subjected to poling in said first state and said third state or in said second state and said fourth state to thereby perform poling treatment on said substrate to be subjected to poling.

11. The plasma poling device according to claim 9, further comprising
a heating mechanism heating said substrate to be subjected to poling, wherein
said substrate to be subjected to poling is a substrate having a dielectric substance.

12. The plasma poling device according to claim 9, claim 9 or claim wherein
said substrate to be subjected to poling is a substrate having a ferroelectric substance.

13. The plasma poling device according to claim 12, comprising
a temperature controlling mechanism controlling the temperature of said substrate to be subjected to poling in performing said poling treatment, to 250° C. or less.

14. The plasma poling device according to claim 12, wherein
a direct-current voltage in forming a direct-current plasma by supplying a power to either said holding electrode or said opposite electrode, or a direct-current voltage component in forming a high frequency plasma is in a range of ±50 V to ±2 kV.

15. The plasma poling device according to claim 12, comprising
a pressure controlling mechanism controlling internal pressure of said poling chamber in performing said poling treatment in a range of 0.01 Pa to atmospheric pressure.

16. The plasma poling device according to claim 12, wherein said gas for forming plasma is one or more of the gases selected from the group consisting of an inert gas, H₂, N₂, O₂, F₂, CₓH_{y}, CₓF_{y}, and air.

17. A piezoelectric substance being obtained by performing poling treatment on a substrate having said ferroelectric substance by using the plasma poling device according to claim 12, to thereby provide said ferroelectric substance with piezoelectric activity.

18. A method of manufacturing a piezoelectric substance comprising the steps of:
preparing a substrate having a ferroelectric substance; and
forming a plasma at a position opposite to said substrate to thereby perform poling treatment on said ferroelectric substance, thus providing said ferroelectric substance with piezoelectric activity to form a piezoelectric substance.

19. The method of manufacturing a piezoelectric substance according to claim 18, wherein
said poling treatment is performed by a plasma poling device, said plasma poling device comprising:
a poling chamber;
a holding electrode being disposed in said poling chamber and holding said substrate thereon;
an opposite electrode being disposed in said poling chamber and being disposed opposite to said substrate held on said holding electrode;
a power source being electrically connected to either said holding electrode or said opposite electrode; and
a gas supply mechanism supplying a gas for forming plasma to a space between said opposite electrode and said holding electrode.

20. The method of manufacturing a piezoelectric substance according to claim 18, wherein
said poling treatment is performed by a plasma poling device, said plasma poling device comprising:
a poling chamber;
a holding electrode being disposed in said poling chamber and holding said substrate thereon;
an opposite electrode being disposed in said poling chamber and being disposed opposite to said substrate held on said holding electrode;
a first power source and a ground potential being connected to said holding electrode via a first selector switch;
a second power source and said ground potential being connected to said opposite electrode via a second selector switch; and
a gas supply mechanism supplying a gas for forming plasma to a space between said opposite electrode and said holding electrode.

21. The plasma poling device according to claim 10, further comprising
a heating mechanism heating said substrate to be subjected to poling, wherein
said substrate to be subjected to poling is a substrate having a dielectric substance.

22. The plasma poling device according to claim 10, wherein
said substrate to be subjected to poling is a substrate having a ferroelectric substance.
